(19) United States
(12) Patent Application Publication
(10) Pub. No.: US 2014/0157942 A1
(43) Pub. Date: Jun. 12, 2014

(54) STROKE SENSOR FOR BRAKE PEDAL DEVICE

(71) Applicants: KIA MOTORS CORPORATION, Seoul (KR); HYUNDAI MOTOR COMPANY, Seoul (KR)

(72) Inventors: Joon Young Park, Seongnam (KR); Chang Hyun Lee, Seoul (KR)

(73) Assignees: KIA MOTORS CORPORATION, Seoul (KR); HYUNDAI MOTOR COMPANY, Seoul (KR)

(21) Appl. No.: 14/103,407

(22) Filed: Dec. 11, 2013

(30) Foreign Application Priority Data
Dec. 12, 2012 (KR) 10-2012-0144829

(51) Int. Cl. G05G 1/38

(52) U.S. Cl. CPC G05G 1/38
USPC 74/512

(57) ABSTRACT

A sensor, in particular a stroke sensor, for a brake pedal device is provided that prevents distortion of the pedal arm from affecting the reliability of the output rotational values. In particular, the sensor is mount on one side of a frame coaxially with a hinged shaft via bracket. A sensor lever is then connected to a rotational shaft of the sensor on one end thereof, and a pin arm is connected to the hinged shaft on one end of the pin arm. Additionally, one side of a sensor pin is connected to another end of the sensor lever and another side of the sensor pin is connected to another end of the pin arm. As a result, distortion to the pedal arm does not affect the values propagated by the sensor.

### CROSS-REFERENCE TO RELATED APPLICATION

This application claims priority to and the benefit of Korean Patent Application No. 10-2012-0144829 filed in the Korean Intellectual Property Office on Dec. 12, 2012, the entire contents of which are incorporated herein by reference.

### BACKGROUND

(a) Field of the Invention

The present invention relates to a stroke sensor for a brake pedal device. More particularly, the present invention relates to a stroke sensor for a brake pedal device that improves operational reliability and precision.

(b) Description of the Related Art

In conventional pedal operation, sensors are used to detect the rotational angle of a pedal arm on both brake pedal devices and accelerator pedal devices in real time in order to precisely control the vehicle based on detection data which is previously stored in the vehicle.

For example, in the brake pedal device, when effort certain amount of force applied to the pedal arm and this force is detected by a stroke sensor, a time differential associated with the detection result is additionally calculated in order to determine the speed at which the brake has been applied, i.e., quickly, slowly, etc. When it is determined that the brake pedal has been depressed quickly, a braking assist program may be executed by a controller in order to improve braking performance.

As described above, the stroke sensor that detects the rotational angle of the pedal arm is provided in the brake pedal device in which one end of the pedal arm is installed on a hinged shaft rotatably mounted in a frame provided in a lower area in front of a driver. That is, the stroke sensor includes a sensor mounted on one side of the frame coaxially with the hinged shaft through a bracket, a sensor lever connected to a rotational shaft of the sensor, and a sensor pin having one side connected to another end of the sensor lever and another side is connected to one side of the pedal arm.

As a result, the operational orbit (i.e., angle) of the pedal arm and the operational orbit (i.e., angle) of the sensor lever are set to be the same. Accordingly, when the rotation of the pedal arm is transmitted to the sensor lever through the sensor pin, the sensor lever rotates the rotational shaft of the sensor to detect the rotational angle of the pedal arm.

However, in this conventional stroke sensor design, a large load is applied to a brake pedal so that a small amount of permanent tension/twisting is generated by the pedal arm and a signal value detected by the stroke sensor is changed as a result. Therefore, operational reliability of the brake pedal device is deteriorated due to an error in an initial sensor value.

The above information disclosed in this Background section is only for enhancement of understanding of the background of the invention and therefore it may contain information that does not form the prior art that is already known in this country to a person of ordinary skill in the art,

### SUMMARY

An exemplary embodiment of the present invention provides a stroke sensor for a brake pedal device in which a sensor pin is connected to a hinged shaft via an additional/second pin arm so that it is possible to insure propagation of a precise rotational angle signal upon operation the a brake pedal in spite of any distortion of the pedal arm and to guarantee operational reliability of a brake pedal device.

According to an exemplary embodiment of the present invention, there is provided a stroke sensor for a brake pedal device in which one end of a pedal arm is installed on a hinged shaft mounted in a frame so that both ends are rotatable, including a sensor mounted on one side of the frame coaxially with the hinged shaft via a bracket. The present invention also includes a sensor lever that is connected to a rotational shaft of the sensor on one end, a pin arm connected to the hinged shaft on one end, and a sensor pin that is connected to another end of the sensor lever on one side of the sensor pin and is connected to another end of the pin arm on another side of the sensor pin.

Additionally, the sensor lever may have an groove into which one side of the sensor pin is inserted that is formed on another end of the sensor level to be combined with the sensor pin via an inserting method. Furthermore, the pin arm may be disposed at a predetermined distance from the pedal arm and may be fixed to an external circumference of the hinged shaft accordingly.

### BRIEF DESCRIPTION OF THE DRAWINGS

FIG. 1 is a perspective view of a stroke sensor for a brake pedal device according to an exemplary embodiment of the present invention.

FIG. 2 is a front view of a stroke sensor for a brake pedal device according to an exemplary embodiment of the present invention.

FIG. 3 is a side view of a stroke sensor for a brake pedal device according to an exemplary embodiment of the present invention.

### DESCRIPTION OF SYMBOLS

10 . . . frame

20 . . . hinged shaft

30 . . . pedal arm

40 . . . bracket

100 . . . stroke sensor for brake pedal device

110 . . . sensor

111 . . . rotational shaft

120 . . . sensor lever

121 . . . inserting groove

130 . . . pin arm

140 . . . sensor pin

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. and other alternative fuel vehicles (e.g. fuels derived from resources other than petroleum).

Hereinafter, an exemplary embodiment of the present invention will be described in detail with reference to the accompanying drawings.

Since sizes and thicknesses of elements in the drawings are arbitrarily represented for convenience sake, the present invention is not limited to illustrations of the drawings. In order to clearly express portions and regions, thicknesses are exaggerated.

In addition, in order to clearly describe an exemplary embodiment of the present invention, portions that are not related to description are omitted.

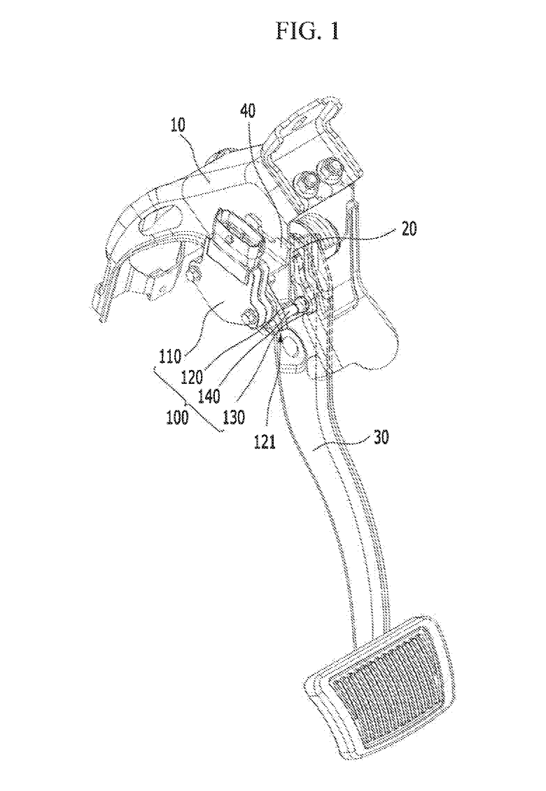

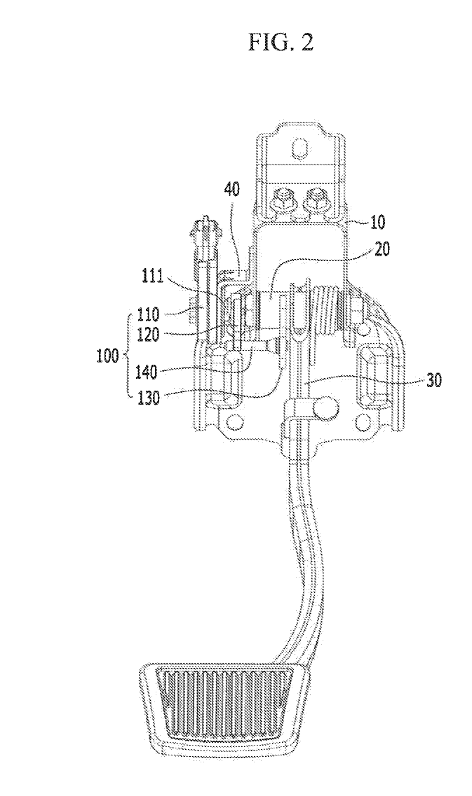

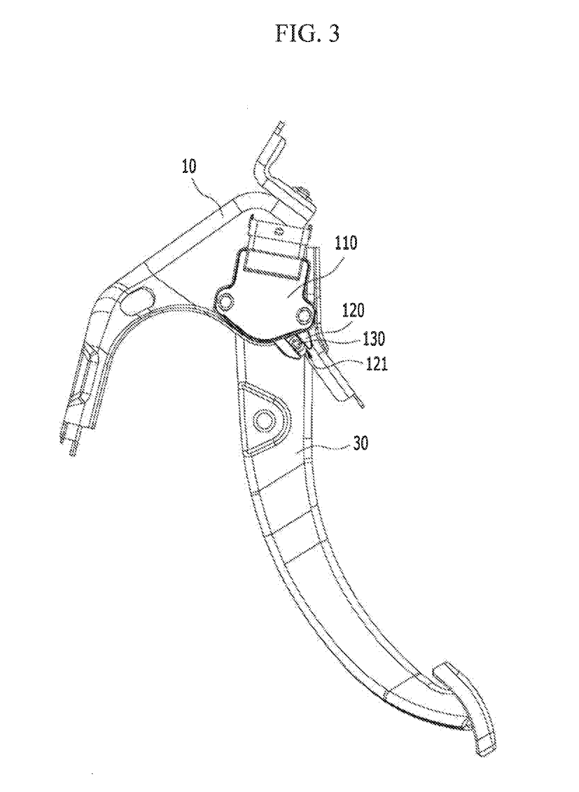

FIG. 1 is a perspective view of a stroke sensor for a brake pedal device according to an exemplary embodiment of the present invention. FIG. 2 is a front view of a stroke sensor for a brake pedal device according to an exemplary embodiment of the present invention. FIG. 3 is a side view of a stroke sensor for a brake pedal is device according to an exemplary embodiment of the present invention.

Referring to FIGS. 1 to 3, a stroke sensor 100 for a brake pedal device according an exemplary embodiment of the present invention is mounted in a brake pedal device in which one end of a pedal arm 30 is installed on a hinged shaft 20 mounted within a frame 10 so that both ends are rotatable. The stroke sensor 100 for a brake pedal device may have a structure in which it is possible to insure of the precise detection of a rotational angle signal of a brake pedal in spite of any distortion of the pedal arm 30 and to improve the operational reliability of a brake pedal device.

More specifically, the stroke sensor 100 for a brake pedal device according to the exemplary embodiment of the present invention includes a sensor 110, a sensor lever 120, a pin arm 130, and a sensor pin 140. First, the sensor 110 is mounted on one side of the frame 10 coaxially with the hinged shaft 20 through a bracket 40. One end of the sensor lever 120 is connected to a rotational shaft 111 of the sensor 110 and a groove 121 is formed on another end of the sensor lever 120.

According to the exemplary embodiment of the present invention, one end of the pin arm 130 is connected to the hinged shaft 20, a predetermined distance is formed between the pin arm 130 and the pedal arm 30 as a result, and the pin arm 130 is fixed to an external circumference of the hinged shaft 20 accordingly.

As such, one side of the sensor pin 140 is connected to another end of the sensor lever 120 and another side of the sensor pin 140 is connected to another end of the pin arm 130. The sensor pin 140 is combined with the sensor lever 120 via any known insertion method where one side of the sensor pin 140 is inserted into the sensor lever 120 through the groove 121 formed on another end of the sensor lever 120. Thus, in the stroke sensor 100 for a brake pedal device, the sensor pin 140 is mounted through the additional pin arm 130 connected to the hinged shaft 20 so that the pedal arm 30 and the sensor pin 140 are prevented from coming in contact with each other. Therefore, it is possible to insure the precise propagation of the rotational angle signal during operation of the brake pedal in spite of the distortion of the pedal arm 30 and to improve the operation reliability of the brake pedal device.

Therefore, when the stroke sensor 100 for a brake pedal device according to the exemplary embodiment of the present invention is applied, the sensor pin 140 is connected to the hinged shaft 20 through the additional pin arm 130 so that it is possible to secure the precision of the rotational angle signal of the brake pedal in spite of any distortion of the pedal arm 30 and to improve the operation reliability of the brake pedal device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed:

1. A brake pedal device comprising:
a pedal arm installed on a hinged shaft mounted within a frame so that both ends are rotatable
a sensor mounted on one side of the frame coaxially with the hinged shaft via a bracket;
a sensor lever that is connected to a rotational shaft of the sensor on one end thereof;
a pin arm that is connected to the hinged shaft on one end thereof; and
a sensor pin that is connected to another end of the sensor lever on one side of the sensor pin and is connected to another end of the pin arm on another side of the sensor pin.

2. The stroke sensor for a brake pedal device of claim 1, wherein the sensor lever includes a groove into which one side of the sensor pin is inserted that is formed on another end of the sensor lever and is combined with the sensor pin by an insertion method.

3. The stroke sensor for a brake pedal device of claim 1, wherein the pin arm is disposed a predetermined distance from the pedal arm and is fixed to an external circumference of the hinged shaft.

4. The stroke sensor for a brake pedal device of claim 1, wherein the pedal arm and the sensor pin I are prevented from coming in contact with each other.4. A sensor mounted to a brake pedal device of a vehicle comprising:
a sensor lever that is connected to a rotational shaft of the sensor on one end;
a pin arm that is connected to a hinged shaft of a pedal arm of the brake pedal device on one end of the pin arm; and
a sensor pin that is connected to another end of the sensor lever on one side thereof and is connected to another end of the pin arm on another end of the sensor pin.

5. The sensor of claim 4, wherein the sensor lever includes a groove into which one side of the sensor pin is inserted that is formed on another end of the sensor lever and is combined with the sensor pin by an insertion method.

6. The stroke sensor of claim 5, wherein the pin arm is disposed a predetermined distance from the pedal arm and is fixed to an external circumference of the hinged shaft.

7. The sensor of claim 1 wherein the sensor is a stroke sensor.

8. The stroke sensor for a brake pedal device of claim 4, wherein the pedal arm and the sensor pin are prevented from coming in contact with each other.
